(19) United States
(12) Patent Application Publication
(10) Pub. No.: US 2023/0185986 A1
(43) Pub. Date: Jun. 15, 2023

(54) ANOMALY DETECTION SYSTEM FOR A CYBER-PHYSICAL SYSTEM

(71) Applicant: Singapore University of Technology and Design, Singapore (SG)

(72) Inventors: Aditya Prasad MATHUR, Singapore (SG); Surabhi ATHALYE, Singapore (SG); Wong Chong CHOW, Singapore (SG)

(21) Appl. No.: 17/924,987

(22) PCT Filed: May 5, 2021
(86) PCT No.: PCT/SG2021/050245

§ 371 Date: Nov. 11, 2022

(30) Foreign Application Priority Data
May 11, 2020 (SG) 10202004335S

(51) Int. Cl. G06F 30/18

(52) U.S. Cl. CPC G06F 30/18

(57) ABSTRACT

A method for automatically generating an anomaly detection system for a cyber-physical system. A directed graph is obtained from the cyber-physical system's design. The directed graph has nodes representing control components of the cyber-physical system that control physical processes. The directed graph is traversed to determine associated control components from the nodes and edges based on predefined parameters. Invariants are derived from the associated control components based on physical/chemical properties governing them. The invariants define conditions for detecting anomalies of the physical processes and are configured as an executable invariant computer program. Upon execution, the anomalies are detectable in response to determining that measurements from the control components have violated the invariant conditions.

### CROSS REFERENCE TO RELATED APPLICATION(S)

The present disclosure claims the benefit of Singapore Patent Application No. 10202004335S filed on 11 May 2020, which is incorporated in its entirety by reference herein.

### TECHNICAL FIELD

The present disclosure generally relates to an anomaly detection system for a cyber-physical system. More particularly, the present disclosure describes various embodiments of a computerized method for automatically generating the anomaly detection system for detecting anomalies such as those due to cyberattacks on the cyber-physical system.

### BACKGROUND

Utilities systems or public utilities, such as water treatment plants, oil/natural gas plants, power generation plants, and power distribution grids, are often at risk of anomalies that may arise due to cyber-physical attacks or malicious cyber-physical activity. A utilities system has a physical subsystem that is controlled by a cyber subsystem. A cyber-physical attack on the utilities system refers to an attempt to disrupt the physical processes or operations of the physical system through the manipulation of cyber and/or physical components of the utilities system. The utilities system may also be referred to as a Cyber-Physical System (CPS) or Industrial Control System (ICS). The cyber subsystem has networked embedded computation and communication devices, e.g. programmable logic controllers (PLCs), Remote Terminal Units (RTUs), and a Supervisory Control and Data Acquisition (SCADA) system/workstation, as well as components such as sensors and actuators or monitoring, measure, and control of the physical processes.

The cyber subsystem of a utilities system may include one or more control stages, each control stage for controlling one physical process. The control actions by the PLCs are based on the current process state obtained through the sensors, and the control actions subsequently alter the process state. For example, in a water treatment plant, the PLCs may communicate instructions to an actuator, e.g., a pump, to fill a tank with water. The pump is instructed to stop when the tank reaches a predetermined level. Physical data for the water level in the tank is communicated to the PLCs through a level sensor. Thus, the PLCs receive physical data from the sensors, compute control actions, and apply these actions to the actuators.

The communications infrastructure of a utilities system, often using wired and/or wireless communications, may be connected to an external network. However, such connections render the utilities system susceptible to cyberattacks. Such attacks may compromise the communication links between sensors, actuators, and the PLCs, as well as across the PLCs and SCADA system. Each such link is considered as an attack point in the utilities system. Once a link has been compromised, an attacker can send fake or false state (sensor) data to the PLCs, or bypass the PLCs and directly control the actuators. Unless the defense system of the utilities system is robust, such attacks are able to cause an undesirable response that may lead to system shutdown and/or component damage. Furthermore, it is assumed that an attacker has access to any one or more control stages of the utilities system. Thus, the attacker is able to compromise components in one or more control stages to which access is available. In many complex utilities systems, the PLCs are often distributed. Although attacking more than one control stage simultaneously might be difficult, it is known to be feasible.

Many existing cyber-physical attack detection solutions for utilities systems are extensions of the traditional network-centric defense system or infrastructure such as firewalls and other network-based logic to prevent intrusions into a utilities system. Such solutions are aimed at preventing unauthorized access into the utilities system. However, social engineering and software vulnerabilities may still enable an attacker to obtain access to the utilities system, potentially leading to component damage and significant deviation from desired behaviour of the physical processes operative in the utilities system.

Assuming that an attacker has bypassed the traditional network-centric defense system, a variety of attacks can be launched in such a situation. While some attacks may focus only on a few components of the utilities system, others may compromise the entire utilities system. For example, bypassing the traditional network-centric defense system exposes the PLCs to the attacker, potentially compromising the logics of the PLCs. This may result in the PLCs computing false/fake sensor data that affect performance of the physical processes. For example, the PLCs may be led by the attacker to believe that a physical process is operating normally, when in fact the physical process is behaving anomalously. The actuators may also be directly controlled by the attacker to behave anomalously and affect performance of the physical process.

In various utilities systems, there are many possible types of cyber-physical attacks that lead to undesirable or anomalous behaviour and performance of physical processes operative in the utilities systems. One type of cyberattacks is a man-in-the-middle attack to maliciously manipulate sensor data and/or status of the actuators. For example in a water treatment plant, the intention of such an attack may be to cause a tank to overflow or a reduction in the performance measured as gallons of water produced per minute. Other types of cyberattacks or attack vectors include, but are not limited to, malware injection into the PLCs, Denial of Service (DOS) or Distributed DOS (DDOS).

Some existing anomaly detection solutions that have been developed for use in utilities systems to detect anomalies or cyberattacks include those from Radiflow, Cyber X, and Nozomi Networks and these solutions use machine learning technology to generate attack detectors. Rules are manually or semi-automatically generated and refined to improve the performance of the attack detectors. These detectors use machine learning technology to learn system behaviour and then use it to predict the plant state during operation. Hence, such detectors can only be used when there is available data for the detectors to learn. Such data is available for collection and learning only when a plant is in operation and the physical processes are operational and have stabilized. Although such data may be available if there is a computer simulation of the plant, such data is unlikely to be a fully accurate reflection of the actual physical processes.

There are other anomaly detection solutions that do not rely on machine learning technology. One example is described in U.S. Pat. No. 10,911,482 as a method of detecting cyberattacks on a cyber-physical system. Specifically, U.S. Pat. No. 10,911,482 describes a distributed attack detection (DaD) method that involves deriving invariants to monitor cyberattacks. However, these invariants are manually generated and this method is only feasible for small plants that contain a few components. It is impractical to implement this method in large plants that may contain hundreds or even thousands of components.

Therefore, in order to address or alleviate at least one of the aforementioned problems and/or disadvantages, there is a need for an improved anomaly detection system.

### SUMMARY

According to an aspect of the present disclosure, there is a computerized method for automatically generating an anomaly detection system for a cyber-physical system comprising a set of computer devices communicative with a set of control components for controlling a set of physical processes. The method comprises: obtaining a directed graph based on a system design of the cyber-physical system, the directed graph comprising a set of nodes representing the control components and a set of edges representing component connections between the control components; traversing the directed graph to determine one or more sets of associated control components from the nodes and edges based on predefined parameters of the cyber-physical system; deriving a set of invariants for each set of associated control components based on a set of physical and/or chemical properties governing the respective associated control components; and configuring the invariants as an invariant computer program executable on the computer devices as the anomaly detection system, the invariants defining a set of conditions for detecting anomalies of the physical processes being controlled by the control components, wherein upon execution of the invariant computer program, the anomalies are detectable in response to determining that measurements from the control components have violated the invariant conditions.

A computerized method for automatically generating an anomaly detection system according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is a flowchart illustration of a computerized method for automatically generating an anomaly detection system for a cyber-physical system, according to embodiments of the present disclosure.

FIG. 2 and FIG. 3 are illustrations of a directed graph obtained using the method, according to embodiments of the present disclosure.

FIG. 4 is a table showing results of redundancy checks in the anomaly detection system, according to embodiments of the present disclosure.

FIG. 5 is a table showing results of performance tests on the anomaly detection system, according to embodiments of the present disclosure.

### DETAILED DESCRIPTION

For purposes of brevity and clarity, descriptions of embodiments of the present disclosure are directed to a computerized method for automatically generating an anomaly detection system, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e., a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “a” and “an” are defined as one or more than one. The use of “/” in a figure or associated text is understood to mean “and/or” unless otherwise indicated. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The recitation of a particular numerical value or value range herein is understood to include or be a recitation of an approximate numerical value or value range.

Embodiments of the present disclosure describe an anomaly detection system for defending a cyber-physical system or utilities system. The anomaly detection system can be used to monitor and detect anomalies of the cyber-physical system, especially cyberattacks and/or physical attacks (collectively referred to as cyber-physical attacks) initiated by malicious entities. The cyber-physical system has a physical subsystem that is controlled by a cyber subsystem. Particularly, the cyber subsystem controls physical processes operative or performed in the utilities system. Each physical process may be considered as a process stage of a collective physical process. Each physical process or process stage of the physical subsystem is controlled by a corresponding control stage of the cyber subsystem. The physical processes are affected by cyber-physical attacks in the cyber-physical system, causing anomalies or abnormalities in the physical processes.

The cyber subsystem includes various control components/devices for monitoring, including measuring and controlling, the physical processes. The control components include one or more sets of controller devices for monitoring process states of the physical processes based on analysis of physical data associated with the physical processes. Each controller device may include a programmable logic controller (PLC). It will be appreciated that the PLCs are generally programmable in a variety of suitable programming languages such as ladder logic, structured text, and functional blocks. Each controller device may additionally or alternatively include a remote terminal unit (RTU). It will be appreciated that the term PLC may also refer to an RTU.

The control components include one or more sets of sensors for collecting the physical data and communicating it to the controller devices. The control components include one or more sets of actuators controllable by the controller devices to execute actions computed/determined by the controller devices. The control components may include a set of supervisory devices such as a SCADA) system/workstation. The SCADA workstation is communicative with the controller devices across the control stages for overall monitoring and control of the physical processes/process stages and collective physical processes.

An exemplary cyber-physical system or utilities system is a water treatment system to perform a water treatment process or collective physical process. One particular example is the Secure Water Treatment (SWaT) plant at Singapore University of Technology and Design (SUTD), Singapore. SWaT can produce 5 gallons per hour of filtered water and mimics a large modern water treatment plant found in cities. The water treatment process can be divided into 6 physical processes/process stages—Stage 1 Raw Water Processing, Stage 2 Chemical Dosing, Stage 3 Ultrafiltration, Stage 4 Dechlorination, Stage 5 Reverse Osmosis, and Stage 6 Backwash. Each physical process is controlled by a corresponding control stage and each control stage has its own set of control components including the controller devices, sensors, and actuators. For example, in a physical process for raw water processing, various physical components are used, such as water tanks, pump, and valve. The controller devices rely on the sensors to obtain physical data for process state estimation and control the actuators, e.g. the pump and/or valve, to control the physical process, i.e. input flow rate of the water. Each controller device obtains data from sensors associated with the corresponding stage, and controls sensors and actuators in its domain. Turning the pumps ON, or opening a valve, causes water to flow either into or out of a tank. Level sensors in each tank inform the controller devices when to turn a pump ON or OFF. Other sensors may be used to check the physical and chemical properties of water flowing through the 6 stages.

Stage 1 controls the inflow of water to be treated by opening or closing a valve that connects the inlet pipe to the raw water tank. Water from the raw water tank is pumped via the chemical dosing station in Stage 2 to an ultrafiltration feed water tank in Stage 3. In Stage 3, an ultrafiltration feed pump sends water, via an ultrafiltration unit, to the dechlorination unit in Stage 4. In Stage 4, the dechlorination unit, such as an ultraviolet dechlorination unit, treats the water to remove any free chlorine from the water prior to passing it through the reverse osmosis unit in Stage 5. Sodium bisulphate (NaHSO₃) can be added in Stage 4 to control the oxidation reduction potential (ORP). In Stage 5, the dechlorinated water is passed through a 2-stage reverse osmosis unit. The filtered water from the reverse osmosis unit is stored in the permeate tank and the reject in the ultrafiltration backwash tank. Stage 6 controls the cleaning of the membranes in the ultrafiltration unit by turning ON or OFF the ultrafiltration backwash pump. The backwash cycle is initiated automatically at intervals, such as once every 30 minutes, and takes less than a minute to complete. Sensors such as differential pressure sensors in Stage 3 measure the pressure drop across the ultrafiltration unit. A backwash cycle may also be initiated when the pressure drop exceeds a predefined level, such as 0.4 bar, indicating that the membranes need immediate cleaning.

The SWaT includes various control components including the controller devices, sensors, and actuators distributed across the 6 stages. These include sensors that relate to the physics of the process such as water level in tanks, flow indicators, and pressure indicators. Additionally, there are sensors that measure chemical properties of water such as pH, conductivity, and hardness. Any control component of the SWaT or any cyber-physical system can be a potential attack point and all control components are assumed to be vulnerable to cyberattacks which could result in anomalies in the cyber-physical system.

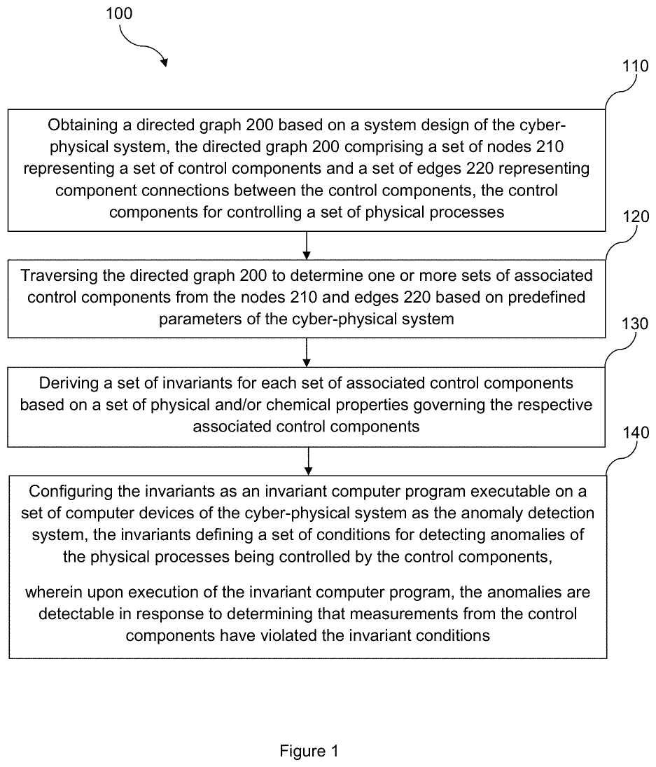

In representative or exemplary embodiments of the present disclosure with reference to FIG. 1, there is a computer-implemented or computerized method 100 for automatically generating an anomaly detection system for a cyber-physical system. The method 100 is performed on a computer or computing device having a computer processor and various steps of the method 100 are performed in response to non-transitory instructions operative or executed by the processor. The non-transitory instructions are stored on a memory of the computer and may be referred to as computer-readable storage media and/or non-transitory computer-readable media. Non-transitory computer-readable media include all computer-readable media, with the sole exception being a transitory propagating signal per se.

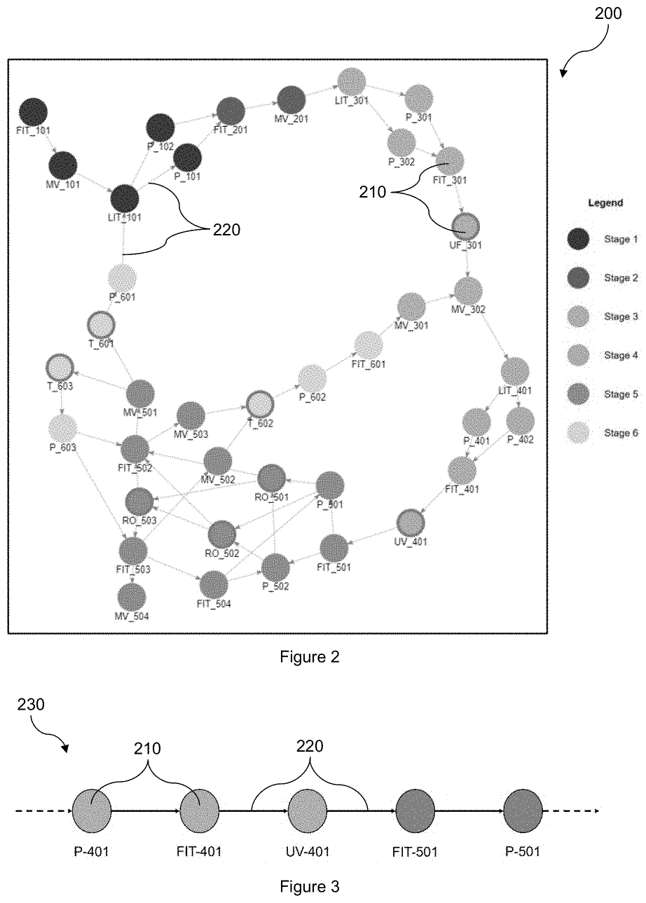

The method 100 includes a step 110 of obtaining a directed graph 200 based on a system design of the cyber-physical system. An exemplary illustration of the directed graph 200 representing the SWaT is shown in FIG. 2. The directed graph 200 includes a set of nodes 210 representing the control components and a set of edges 220 representing component connections between the control components. The control components may include at least one sensor and/or at least one actuator.

In some embodiments, the method 100 includes a step of generating the directed graph 200 based on the system design, such as from an electronic file representing the system design. The method 100 may include a step of retrieving the electronic file, such as from a data input source or an online database. The electronic file may be a computer-aided design (CAD) file or a design diagram such as a line diagram or process and instrumentation diagram (P&ID). It will be appreciated that the electronic file or system design may be in any suitable data format readable by the computer performing the computerized method 100.

To generate the directed graph 200, the method 100 reads the electronic file to understand the system design of the utilities system that the anomaly detection system is intended to defend. Specifically, the method 100 reads the electronic file to obtain the control components (nodes 210), particularly the sensors and actuators, and component connections (edges 220) as tuples. The method 100 then models the system design as the directed graph 200 using predetermined algorithms. For example, the NetworkX library, which is a Python language software package for complex networks, has algorithms that can be used to generate the directed graph 200. The NetworkX library provides functions that take in this set of nodes 210 and edges 220 as an input to generate the directed graph 200. The directed graph 200 may be stored on a database accessible by the computer, so that the method 100 can obtain the directed graph 200 for the same utilities system in future without requiring any external files (e.g. the electronic file representing the system design) and repeatedly generating the directed graph 200.

The method 100 includes a step 120 of traversing the directed graph 200 to determine one or more sets of associated control components from the nodes 210 and edges 220 based on predefined parameters of the cyber-physical system. The NetworkX library may be used to traverse the directed graph 200 to obtain the relevant sets of associated control components, particularly related sensor-actuator configurations.

In the step 120, the method 100 first identifies the control components as either sensors or actuators. Some examples of sensors include level sensors (LIT) and flow sensors (FIT) for tanks (T), and some examples of actuators include pumps (P), valves (MV), reverse osmosis units (R), and ultraviolet dechlorination units (UV). These acronyms are indicated in the directed graph 200 in FIG. 2 together with their associated Stage numbers. For example, FIT_101 represents a flow sensor in Stage 1, T_101 represents a tank in Stage 1, LIT_101 represents a level sensor for the tank T_101, and P_301 represents a pump in Stage 3.

In the step 120, the method 100 then classifies each control component represented in the directed graph by operational type, wherein the control components are associated by their operational type. In one example, when the method 100 traverses the directed graph 200 and reaches a branch or tuple 230 as shown in FIG. 3, the method 100 is able to obtain the relevant sets of associated control components including P_401, FIT_401, UV_401, FIT_501, and P_501. In another example, when the method 100 reaches a pump (P) in the directed graph 200, it searches the preceding and succeeding branches for the source and destination tanks (T) and the respective level sensors (LIT). While conducting this search, the method 100 may skip some of the other connected control components in the branches, such as the flow sensors, to stop only once it reaches a tank (T), because it aims to obtain a LIT-P-LIT set.

The method 100 includes a step 130 of deriving a set of invariants for each set of associated control components based on a set of physical and/or chemical properties governing the respective associated control components. The physical and/or chemical properties may be referred to as atomic laws. An invariant may be defined as a relationship of physical and/or chemical properties of the physical processes operative in the cyber-physical system. The invariant defines a set of conditions for detecting anomalies of the physical processes being controlled by the control components. These conditions describe the expected behaviour of each set of associated control components under normal operation as per their design.

For example, in the SWaT, such a relationship includes the correlation between the level of water in a tank and the flow rate of incoming and outgoing water across this tank. The properties are measured using sensors during the operation of the SWaT and at predetermined intervals. An invariant in SWaT may be derived from these properties for detecting anomalies in the behaviour of the underlying physical process in the SWaT. It will be appreciated that the method 100 may derive invariants for all possible sets of associated control components, such as every pair of connected control components. It will also be appreciated that different atomic laws are applicable to different sets of associated control components to create the respective invariants.

In the example of the SWaT LIT-P-LIT configuration mentioned above, the invariant for this configuration may define a set of conditions as follows. The pump (P) should transfer water from the source tank to the destination tank when required by the destination tank and if the source tank has an adequate amount of water. Each of the source and destination tanks has an LIT to measure the water level in the respective tank. This invariant can be applied to an exemplary control component set LIT_101, P_101, LIT_301 in the SWaT. Specifically, pump P_101 should be running to pump water from source tank T_101 to destination tank T_301 when the water level measured by level sensor LIT_301 in the destination tank T_301 falls below a predefined level and if the water level measured by level sensor LIT_101 in the source tank T_101 is sufficiently high. The corollary is that pump P_101 would be stopped when the water level in LIT_101 falls below a predefined level and the water level in LIT_301 is sufficiently high.

The method 100 includes a step 140 of configuring the invariants as an invariant computer program executable on the computer devices as the anomaly detection system. The invariants are coded and integrated into the control and communications mechanism of the physical processes. The coded invariants may be referred to as monitors as they are configured to monitor the state of the physical processes in real time and to detect anomalies such as due to cyberattacks. The monitors are placed at suitable locations in the cyber-physical system of a plant, such as a water treatment plant like the SWaT. For example, if the plant is still in the design stage, the monitors may be best placed inside the PLCs as well as at different points in the plant communications network. If the plant is operational, placement of the monitors may be constrained due to management policies and the need to minimize service disruption to users.

Upon execution of the invariant computer program, the monitors receive measurements sampled at regular intervals, such as every second, from the control components. These measurements describe the actual behaviour or state of the control components and are compared against the expected behaviour under normal operation to check whether the coded invariants are violated. Anomalies in the underlying physical processes are detectable in response to determining that the measurements have violated the invariant conditions.

The method 100 may include a step of configuring the invariant computer program to trigger an alert in response to identifying a violation of the invariant conditions. However, as invariants may possibly be derived for every pair of control components, there may be some redundant invariants may trigger alerts even during normal operation under some scenarios. These alerts are false alarms that may be triggered even without any actual anomalies. To reduce the incidence of false alarms, the method 100 may include a step of configuring the invariant computer program with a redundancy protocol to identify true and false positives from the detected anomalies. For example, the redundancy protocol includes a series of checks that are performed upon violations of the invariant conditions to account for the possibility of the transitional states of the control components, as well as possible network or technical glitches, before an alert is triggered. For example, these problems may occur due to the transition time of actuators when they change from one stable state to another stable state, as well as any delays in receiving data from the sensors in real-time.

The working of such redundancy checks is described with reference to the control component set LIT_101, P_101, LIT_301 mentioned above. In this case, pump P_101 should be turned on or running when the water level measured by level sensor LIT_301 falls below its lower limit L3 and if the water level measured by level sensor LIT_101 is between its lower limit L1 and upper limit H1. However, due to physical constraints, pump P_101 would take some time to turn on when the lower limit L3 for level sensor LIT_301 is reached. For example, the lower limit L1 is 400 mm, the upper limit H1 is 800 mm, the lower limit L3 is 800 mm, and the LIT_301 level may have an upper limit H3 of 1000 mm.

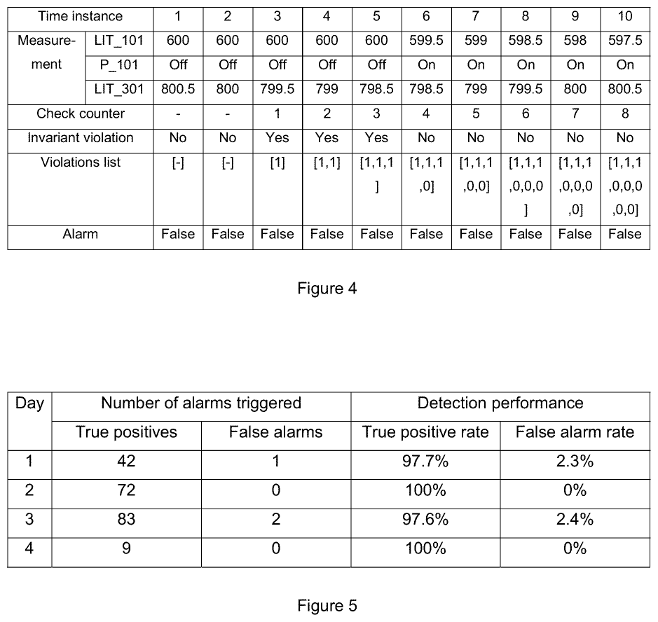

The results of these redundancy checks are shown in FIG. 4. In time instances 1 and 2, the LIT_301 level has not fallen below the lower limit L3, so pump P_101 correctly remains turned off. In time instances 3 to 5, the LIT_301 level has fallen below the lower limit L3 but pump P_101 is still turned off. This would have been detected as an anomaly, since the invariant conditions have been violated and pump P_101 should have been turned on. However, to account for the transition time of turning on pump P_101, the checks override the invariant violations and prevent alerts from being triggered, which would have been false positives. In time instance 6, pump P_101 has turned on and is in a stable operational state to pump water from source tank T_101 to destination tank T_301, as shown by the LIT_101 level. As pump P_101 is correctly turned on, the invariant conditions are not violated. In time instances 7 to 10, pump P_101 continues to pump water from source tank T_101 to destination tank T_301, and the invariant conditions are not violated. Notably in time instance 10, the LIT_101 level is between the lower limit L1 and upper limit H1, while the LIT_301 level is between the lower limit L3 and upper limit H3. Pump P_101 may then be turned off as the LIT_301 level has risen above the lower limit L3. Notably, if pump P_101 remains turned on, then this may be a violation of the invariant conditions.

The results described in FIG. 4 demonstrate that even if the invariant conditions are temporarily violated due to some reason under normal operation, such as shown in time instances 3 to 5, the redundancy checks prevent such false positives from triggering the alerts. However, the invariant violations may be a true positive if the violations are successively detected and/or persist for a continued period, and the alerts should be triggered for the true positive. In other words, a true positive can be identified if the anomalies have been detected successively for more than a predefined duration and/or a predefined number of anomalies have been detected successively. For example, this predefined duration may be at least 5 time instances based on the example in FIG. 4, such as at least 5 seconds. The method 100 then includes a step of configuring the invariant computer program may be configured to trigger the alert in response to identifying the true positive. For example, the predefined number of anomalies may be 5 such that the alert is triggered if 5 or more successive anomalies have been detected.

As described above, the method 100 relies on predefined parameters of the cyber-physical system, and in particular parameters that are specific to the plant that the anomaly detection system is intended to defend. These parameters may include physical device constraints (such as transition time for actuators and normal flow rates) and control set-points. Plant operators can calibrate the parameters to customize the anomaly detection system for a specific plant and to better suit the plant's infrastructure. When the invariant conditions are checked, the actual measurements are normalized using the corresponding normal values obtained from the plant-specific parameters. For example, for a flow sensor, the actual measurement may be represented as ≥δ or <δ and normalized based on the normal flow rate δ for the flow sensor. This normalization can account for positive values in the flow rate measurements even when there is no water flow. Moreover, for actuators that take longer to stabilize after changes in states, the number of invariant violations and/or the predefined duration for detection of successive anomalies before alerts are triggered can be set to a higher value. This allows more time for the plant to revert to normal operation and helps to enhance the anomaly detection accuracy as well as decreasing instances of false alarms.

The anomaly detection system includes or is communicative with a user interface for visualizing the entire anomaly detection process during plant operation. Alerts that have been triggered are sent to a user interface for the plant operators to view and for them to make necessary changes in the plant operations to rectify the anomalies. The results of the redundancy checks and the alerts are presented on the user interface in an output format that is easily visualized and comprehended by the plant operators. An example of the user interface is PlantViz.

The anomaly detection system generated for a water treatment plant was tested in a cyber-security exercise simulating practical cyberattack situations. During this exercise, attackers launched cyberattacks on the water treatment plant and created anomalies in the physical processes. The test results of the anomaly detection system are shown in FIG. 5. The true positive rate refers to the number of times the anomaly detection system correctly triggered an alarm in the event of an attack. The false alarm rate indicates the tendency of the anomaly detection system to incorrectly trigger alarms in the absence of attacks. More importantly, the performance anomaly detection system was the best among all the detectors used in the same exercise.

As described herein, the method 100 is able to automatically generate the anomaly detection system directly from plant design documents, such as CAD files, together with predetermined algorithms, such as the NetworkX library, to automatically derive the invariants for detecting anomalies. The anomaly detection system is design-centric and can be used at the time of plant design as well as during plant operation, spanning the whole life cycle of the physical processes implemented in the plant. Thus, the design-centric anomaly detection system is advantageous over data-centric detectors that rely on machine learning technology as the design-centric anomaly detection system enables security-by-design of critical cyber-physical systems infrastructure.

The anomaly detection system is suitable for the protection of critical infrastructure against cyberattacks. Modern critical infrastructure often involves large numbers of control components that work in tandem to allow the cyber-physical system to operate efficiently. Using existing detectors to manually derive the invariants for large complex systems would be a tedious and error prone task due to the high number and diverse types of control components. The anomaly detection system of the present disclosure addresses this problem by automating the entire process of invariant generation. Hence, by automating this process for realistic large plants, the anomaly detection system allows for reliability and efficiency in detecting the anomalies in the plants. Given that the invariants are derived based on atomic laws which are derived from sciences like physics and chemistry, the anomaly detection system is applicable to a wide range of critical utilities systems. These include but are not limited to water treatment plants, electric power grids, natural gas plants, etc.

In the foregoing detailed description, embodiments of the present disclosure in relation to a computerized method 100 for automatically generating an anomaly detection system are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A computerized method for automatically generating an anomaly detection system for a cyber-physical system comprising a set of computer devices communicative with a set of control components for controlling a set of physical processes, the method comprising:
obtaining a directed graph based on a system design of the cyber-physical system, the directed graph comprising a set of nodes representing the control components and a set of edges representing component connections between the control components;
traversing the directed graph to determine one or more sets of associated control components from the nodes and edges based on predefined parameters of the cyber-physical system;
deriving a set of invariants for each set of associated control components based on a set of physical and/or chemical properties governing the respective associated control components; and
configuring the invariants as an invariant computer program executable on the computer devices as the anomaly detection system, the invariants defining a set of conditions for detecting anomalies of the physical processes being controlled by the control components,
wherein upon execution of the invariant computer program, the anomalies are detectable in response to determining that measurements from the control components have violated the invariant conditions.

2. The method according to claim 1, wherein the control components comprise at least one sensor and/or at least one actuator.

3. The method according to claim 1, further comprising generating the directed graph based on the system design.

4. The method according to claim 3, further comprising retrieving an electronic file representing the system design.

5. The method according to claim 4, wherein the electronic file is a CAD file or a P&ID file.

6. The method according to claim 1, further comprising classifying each control component represented in the directed graph by operational type, wherein the control components are associated by their operational type.

7. The method according to claim 1, further comprising configuring the invariant computer program with a redundancy protocol to identify true and false positives from the detected anomalies.

8. The method according to claim 7, wherein a true positive is identified if the anomalies have been detected successively for more than a predefined duration.

9. The method according to claim 7, wherein a true positive is identified if a predefined number of anomalies have been detected successively.

10. The method according to claim 7, further comprising configuring the invariant computer program to trigger an alert in response to identifying the true positive.

11. A non-transitory computer-readable storage medium storing computer-readable instructions that, when executed, cause a computer system to perform the method according to claim 1.
